(19) United States
(12) Patent Application Publication
(10) Pub. No.: US 2020/0211447 A1
(43) Pub. Date: Jul. 2, 2020

(54) Display Panel with Data Passthrough

(71) Applicant: Ultravision Technologies, LLC, Dallas, TX (US)

(72) Inventors: Chris Mays, Coppell, TX (US); Srinivasan Chakravarthi, Lucas, TX (US)

(21) Appl. No.: 16/564,530

(22) Filed: Sep. 9, 2019

Related U.S. Application Data
(60) Provisional application No. 62/729,304, filed on Sep. 10, 2018.

(51) Int. Cl. G09G 3/32; G06F 3/14

(52) U.S. Cl. CPC G09G 3/32; G06F 3/1446; G09G 2370/02; G09G 2300/026; G09G 2330/021

(57) ABSTRACT

Methods and systems for operating a display panel in a multi-panel display system are presented. In one or more embodiments, a display panel may receive data and power; at a power supply, the display panel may generate a supply voltage from the received power for powering the display panel; and the display panel may forward the received data to an adjacent display panel if or when the power supply fails to generate the supply voltage.

### CROSS-REFERENCE TO RELATED APPLICATIONS

This application claims the benefit of U.S. Provisional Application No. 62/729,304, filed on Sep. 10, 2018 which application is hereby incorporated herein by reference.

### TECHNICAL FIELD

The present invention relates generally to display panels, and in particular embodiments, to systems and methods for a modular multi-panel display.

### BACKGROUND

Large displays (e.g., billboards), such as those commonly used for advertising along roads or inside buildings such as airports, stadiums, generally have one or more pictures and/or text that are to be displayed under various light and weather conditions. As technology has advanced and introduced new lighting devices such as the light emitting diode (LED), such advances have been applied to large displays. Many video displays now utilize LEDs in their design because LEDs typically consume less electrical energy than conventional light sources, such as incandescent lamps, fluorescent lamps, and neon tubes. Additionally, LEDs generally possess a much longer lifetime with lower maintenance costs as compared to conventional light sources. Conventional displays may be flat-panel displays, which may use an array of LEDs. The LEDs on the flat-panel displays may be discrete LEDs or surface-mounted device (SMD) LEDs. Most outdoor screens and some indoor screens are built around discrete LEDs, which are also known as individually mounted LEDs. A cluster of red, green, and blue diodes is driven together to form a full-color pixel, usually square in shape. These pixels are spaced evenly apart and are measured from center to center for absolute pixel resolution.

A large display may be made of a single flat-panel display or a panel of smaller flat-panel displays. Creating a large display out of a panel of smaller flat-panel displays may be economically advantageous, since it may be less costly to combine several smaller flat-panel displays rather than producing a large flat-panel display. However, this solution is not without its own set of problems. For example, directly cabling each flat-panel display to a common data source and/or a common power source may require an excessive amount of cabling that may be heavy, expensive, and cumbersome to install and maintain. The amount of cabling required may be reduced by daisy-chaining the flat-panel displays, or connecting the flat-panel displays in series. However, this cabling configuration introduces a risk that a single failure in a display may cause most, if not all, displays to be off because they are no longer receiving data and/or power from further upstream in the daisy-chain. This risk may be mitigated by connecting both ends of the daisy-chain to the data source and/or power source. However, the risk is not completely eliminated because a large proportion of flat-panel displays may still go off if two (or more) flat-panel displays fail.

### SUMMARY

Example embodiments of the present specification provide systems and methods for operating a display panel in a multi-panel display system if or when a power supply in the display panel has failed. The following summary merely presents some concepts in a simplified form as an introductory prelude to the more detailed description provided below.

In accordance with an example embodiment of the present specification, a method for operating a display panel is provided. The method may comprise receiving data and power at the display panel; at a power supply, generating a supply voltage from the received power for powering the display panel; and forwarding the received data to an adjacent display panel if or when the power supply fails to generate the supply voltage.

In accordance with another example embodiment of the present specification, a modular display of a multi-display system is provided. The modular display may comprise a plurality of light-emitting diodes (LEDs) arranged to form a display surface of the modular display; a power supply configured to power the plurality of LEDs; a network switch, powered by the power supply, configured to receive data and forward the received data to the adjacent modular display; and a bypass circuit configured to bypass the network switch and forward the received data to the adjacent modular display if or when the power supply fails.

In accordance with another example embodiment of the present specification, a multi-panel display system is provided. The multi-panel display system may comprise a mechanical support structure; and a plurality of display panels mounted to the mechanical support structure, wherein each display panel comprises: a plurality of light-emitting diodes (LEDs) arranged to form a display surface of the display panel; a power supply for powering the plurality of LEDs; a network switch, powered by the power supply, for receiving incoming data packets and for forwarding outgoing data packets to the adjacent next display panel; and a bypass circuit for bypassing the network switch if or when the power supply fails.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates one embodiment of a multi-panel display system that may be provided in accordance with one or more example embodiments;

FIG. 2 depicts one embodiment of a display configuration that may be used with a display panel in a multi-panel display system in accordance with one or more example embodiments;

FIG. 3, which includes FIGS. 3A and 3B, illustrate the power and data connections of a multi-panel display system that may be provided in accordance with one or more example embodiments;

FIG. 4 depicts an illustrative architecture of a display panel that may be provided in accordance with one or more example embodiments;

FIG. 5 depicts another illustrative embodiment of a display panel in accordance with one or more example embodiments;

FIG. 6, which includes FIGS. 6A and 6B, illustrates another embodiment of a display panel that may be used with a display panel in a multi-panel display system in accordance with one or more example embodiments;

FIG. 7, which includes FIGS. 7A-7D, depicts another illustrative embodiment of a display panel in accordance with one or more example embodiments;

FIG. 8 illustrates another embodiment of a display panel in accordance with one or more example embodiments;

FIG. 9, which includes FIGS. 9A and 9B, depicts another illustrative embodiment of a display panel in accordance with one or more example embodiments; and

FIG. 10, which includes FIGS. 10A and 10B, illustrates another embodiment of a display panel that may be used with a display panel in a multi-panel display system in accordance with one or more example embodiments.

### DETAILED DESCRIPTION OF ILLUSTRATIVE EMBODIMENTS

To overcome limitations in the prior art described above, and to overcome other limitations that will become apparent upon reading and understanding the present specification, aspects described herein are directed towards systems, methods, and techniques for operating a display panel in a multi-panel display system if or when a power supply in the display panel has failed. While the present specification demonstrates the use of LED-based display panels, any kind of addressable display technology may be used. For example, phosphorescent, electroluminescent, organic/inorganic emissive, reflective, or other known display technologies may be used. Advantageously, the multi-panel display system described herein allows for the reduction of image loss if or when one or more display panels of the multi-panel display system have failed.

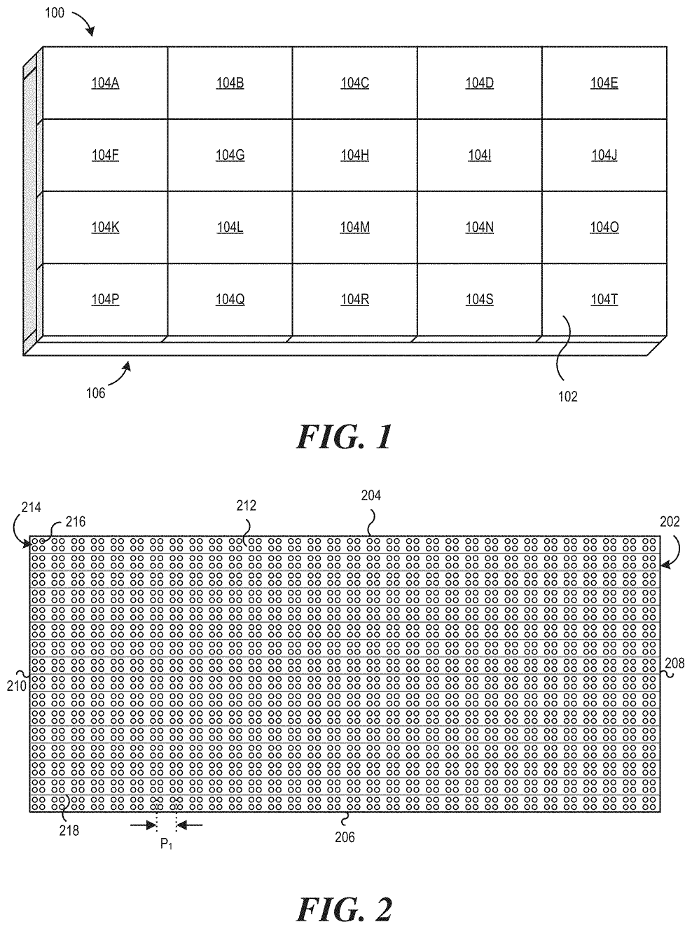

FIG. 1 depicts an illustrative embodiment of a multi-panel display system 100. The multi-panel display system 100 may comprise a display surface 102 that may be formed by a plurality of display panels 104A-104T (henceforth referred to as 104.) Although FIG. 1 depicts an arbitrarily chosen twenty display panels (i.e., 104A-104T) in a 4×5 configuration, it is understood that multi-panel display system 100 may comprise any number of display panels in any number of possible configurations. In one embodiment, the display panels 104 may use light emitting diodes (LEDs) for illumination, but it is understood that other light sources may be used in other embodiments. For example, any kind of addressable display technology may be used, such as phosphorescent, electroluminescent, organic/inorganic emissive, reflective, or other known display technologies may be used. The display panels 104 may typically operate together to form a single image on display surface 102, although multiple images may be simultaneously presented by the multi-panel display system 100. As shown in FIG. 1, the display panels 104 may be attached to a frame 106, which may enable each display panel 104 to be installed or removed from the frame 106, which may include any type of mechanical support structure without affecting the other display panels 104.

Each display panel 104 may comprise a self-contained unit that may be coupled to the frame 106. In some embodiments, another component or components may be positioned between the display panel 104 and the frame 106. In one embodiment, the plurality of display panels 104A-104T may be aligned with each other by the frame 106. In another embodiment, an alignment plate (not shown) may be coupled to a display panel 104 and/or to the frame 106 to aid in aligning a display panel 104 with other display panels 104. Additionally or alternatively, a corner plate (not shown) could be used. The display panel 104 may then be coupled to the frame 106 or to the alignment plate and/or to the corner plate. It is understood that many different coupling mechanisms may be used to attach display panels 104 to the frame 106. Such coupling mechanisms may comprise the use of bolts, screws, latches, clips, and/or any other fastener suitable for attaching a display panel 104 to the frame 106.

Two or more display panels 104 may be coupled for power and/or data purposes, with a display panel 104 receiving power and/or data from a central source or from another display panel 104 and passing through at least some of the power and/or data to one or more other display panels 104. Power cables and data cables (not shown) for the display panels 104 may route around and/or through the frame 106. This may further improve the modular aspect of the multi-panel display system 100, as a single display panel 104 may be easily connected/disconnected to the multi-panel display system wo if or when the display panel 104 is being installed/removed.

The power and data connections for the display panels 104 may be configured using one or more layouts, such as a ring, mesh, star, bus, tree, line, or fully-connected layout, or a combination thereof. In some embodiments, the display panels 104 may be coupled to a single network, while in other embodiments, the display panels 104 may be divided into multiple networks. Power and data may be distributed using identical or different layouts. For example, power may be distributed in a line layout, while data may use a combination of line and star layouts.

As will be described in various embodiments below, the display panels 104 are designed to include redundancy circuits that enable data pass-through from one panel to another even if the corresponding panel loses power.

Referring to FIG. 2, one embodiment of a display panel 200 is illustrated that may be used as one of the display panels 104 of FIG. 1. FIG. 2 illustrates a front view of the embodiment display panel 200 with LEDs aligned in a 16×32 configuration. It is understood that the display panel configuration depicted in FIG. 2 is for illustrative purposes only. Those of skill in the art will appreciate that the configuration of the embodiment display panels 200 may vary, and are secondary to the functionality that they provide, as further described herein. Embodiment display panel 200 may comprise a substrate 202 that may form a front surface 212 of the embodiment display panel 200. The substrate 202 in the example embodiment is rectangular in shape, with a top edge 204, a bottom edge 206, a right edge 208, and a left edge 210. A front surface 212 may comprise pixels 214 that may be formed by one or more LEDs 216 mounted on or within the substrate 202. As shown in FIG. 2, each pixel 214 may comprise four LEDs 216 arranged in a pattern (e.g., a square). For example, the four LEDs 216 that form a pixel 214 may comprise a red LED, a green LED, a blue LED, and one other LED (e.g., a white LED). In some embodiments, the other LED may be a sensor. It is understood that more or fewer LEDs 216 may be used to form a single pixel 214, and that the use of four LEDs 216 and their relative positioning as a square is for purposes of illustration only. In other embodiments, a single tri-color LED having red, green, and blue inputs may form a single pixel 214.

In some embodiments, the substrate 202 may form the front surface 212 of the embodiment display panel 200 but may not form the outer surface in other embodiments. In such scenarios, for example, a waterproofing material or coating, such as a potting compound, may overlay the substrate 202, thereby being positioned between the substrate 202 and the environment. Similarly, the back surface of the substrate 202 may comprise a similar coating. The coatings may be configured to make the embodiment display panel 200 waterproof, for example, to have a ingress protection (IP) rating of IP65 or higher.

The LEDs 216 used by embodiment display panel 200 may be of one of several types. For example, in some embodiments, the LEDs 216 may be Surface Mount Device (SMD) LEDs. Whereas, in other embodiments, the LEDs 216 may be Dual Inline Package (DIP) LEDs. The LEDs 216 may be mounted at different spacing intervals, or pitches, in order to obtain the desired resolution. In other words, the pitch may indicate the distance between any two pixels 214 in the embodiment display panel 200. The resolution obtained by the embodiment panel may be affected by the pitch and by the type of LEDs used. In some embodiments, all the embodiment display panels 200 may have the same resolution. For example, all the embodiment display panels 200 may use the same type of LED installed at the same pitch. As illustrated in FIG. 2, LEDs 216 may be DIP-type LEDs mounted at a pitch of P1. In one or more embodiments, LEDs 216 may be mounted at pitches of about 0.2 mm, 0.5 mm, 1 mm, 1.8 mm, 3.8 mm, 6.35 mm, 7.62 mm, 9.525 mm, 12.7 mm, 15.24 mm, 19.05 mm, 25.4 mm, and 30.48 mm as examples. In other embodiments, the resolution of some embodiment display panels 200 may be different to the resolution of the remaining embodiment display panels 200. For example, in one such scenario, the resolution of embodiment display panels 200 towards the bottom of the multi-panel display system 100 may be lower than the resolution of the embodiment display panels 200 towards the top of the system. In yet other embodiments, the embodiment display panels 200 may utilize enhanced pixel technology (EPT) to increase image capability and resolution. For example, by driving the four LEDs 216 in each pixel 214 independently, adjacent pixels 214 may share LEDs 216 horizontally and vertically which may result in a doubling of the pixel density. EPT may allow embodiment display panels 200 to display video images using the physical pitch spacing, but may also allow the display of video images in a resolution up to four-times greater.

Louvers 218 may be positioned above each row of pixels 214 to block or minimize light from directly striking the LEDs 216 from certain angles. For example, the louvers 218 may be configured to extend from the substrate 202 to a particular distance and/or at a particular angle needed to shade each pixel 214 if or when a light source (e.g., the sun) is at a certain position (e.g., ten degrees off vertical). The louvers 218 may extend the entire length of the substrate 202, but it is understood that other louver configurations may be used.

As will be described in various embodiments below, the display panel 200 is designed to include redundancy circuits that enable data pass-through from this panel to another even if this panel loses power.

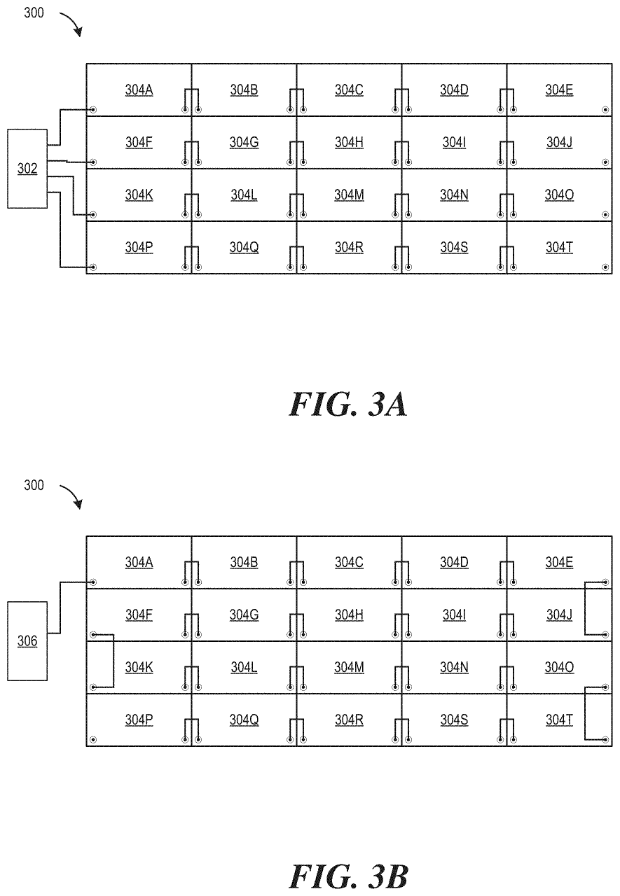

FIGS. 3A and 3B illustrate an embodiment of power and data connections of a multi-panel display system 300. Multi-panel display system 300 may be similar or identical to the multi-panel display system 100 described in FIG. 1 and may include additional features not mentioned above. Similarly, display panels 304A-304T (henceforth referred to as 304) may be similar or identical to the display panels described in the previous figures (i.e., FIGS. 1-2) and may include additional features not mentioned above. For purposes of example, multi-panel display system 300 may comprise twenty display panels 304 (i.e., 304A-304T) arranged in four rows and five columns. It is understood that the number of panels and configuration of multi-panel display system 300 as illustrated in FIGS. 3A and 3B is for illustrative purposes only and that multi-panel display system 300 may comprise any number of display panels in any number of possible configurations.

As illustrated in FIG. 3A, power panel 302 may provide power (e.g., 220V single-phase) to the display panels 304 via four breakers (e.g., twenty ampere breakers), with a breaker assigned to each row of the four rows in the display panel configuration. In the present embodiment, power may be provided in a serial manner along a row, with power provided to the first column display panel 304A via the power panel 302, to the second column display panel 304B via the first column display panel 304A, to the third column display panel 304C via the second column display panel 304B, to the fourth column display panel 304D via the third column display panel 304C, and to the fifth column display panel 304E via the fourth column display panel 304D. Accordingly, if or when a display panel 304 is removed or the power for a display panel 304 is unplugged, the remaining display panels 304 in the row may lose power. As previously discussed, power connections for the display panels 304 may be coupled using other layouts than the one illustrated in FIG. 3A. For example, in other embodiments, the power connections for the display panels 304 may utilize one or more layouts, such as a ring, a mesh, a star, a bus, a tree, a line, a fully-connected layout, or a combination thereof.

Referring to FIG. 3B, data may be provided in a serial manner along a row and then jumping from one row to the next once the end of the row is reached. In the present embodiment, data may be provided from a data controller 306 to the first column display panel in the first row (i.e., display panel 304A), to the second column display panel 304B from the first column display panel 304A, to the third column display panel 304C via the second column display panel 304B, to the fourth column display panel 304D via the third column display panel 304C, to the fifth column display panel 304E via the fourth column display panel 304D, to the fifth column display panel in the second row 304J via the to the fifth column display panel in the first row 304E, and so on. Accordingly, if or when a display panel 304 is removed or the data cables for a display panel 304 are unplugged, the remaining display panels 304 that are fed by the display panel 304 may lose data. As previously discussed, data connections for the display panels 304 may be coupled using other layouts than the one illustrated in FIG. 3B. For example, in other embodiments, the two top rows of multi-panel display system 300 (i.e., display panels 304A-304J) may be connected to a first network and the two bottom rows (i.e., display panels 304K-304T) may be connected to a second network. In such a scenario, the first set of display panels (i.e., display panels 304A-304J) may be connected to a first data source and the second set of display panels (i.e., display panels 304K-304T) may be connected to a second data source. Additionally or alternatively, the two sets of display panels (i.e., display panels 304A-304J and display panels 304K-304T) may be coupled to a single data controller 306. In another embodiment, the display panels 304 may be coupled to the data controller 306 via a loop. For example, in such a scenario, the last display panel in the series (i.e., display panel 304P) may be coupled to data controller 306 and data controller 306 may be further configured to provide data both to the first display panel 304A and to the last display panel 304P and the data may travel bi-directionally between the display panels 304. In yet other embodiments, the data connections for the display panels 304 may utilize one or more layouts, such as a ring, a mesh, a star, a bus, a tree, a line, a fully-connected layout, or a combination thereof. Furthermore, the connection layout for the data connections may differ from the connection layout for the power connections. For example, power may be distributed in a line layout, and data may be distributed using a combination of line and star layouts.

In some embodiments, the data connections may comprise both data and power. For example, the data connections may comprise twisted-pair cables (e.g., Cat 5) that may carry both data and power signals, such as Power over Ethernet (PoE). In such scenarios, and as described in further detail below, display panels 304 may utilize the power signals carried by the data connections to provide power to network devices and/or network elements that may be comprised by the display panels and may be coupled to the data connections.

Multi-panel display system 300 may comprise a data controller 306 for providing data to be displayed by the display panels 304. In some embodiments, multi-panel display system 300 may comprise more than one data controller 306. Data controller 306 may receive data to be displayed from another computing device, such as a media server, or the data controller 306 may also be part of the computing device. Data controller 306 may be remotely located in some embodiments or may be located on-site in other embodiments. Data controller 306 may be coupled to the display panels 304 via a network cable. Alternatively or additionally, the coupling between the data controller 306 and the display panels 304 may comprise a wireless network connection. In other embodiments, the network connection may be effectuated via the internet. In such a scenario, the data controller 306 may be located remotely and may communicate with the display panels 304 via the internet. The data controller 306 may communicate with the display panels 304 using an internet communication protocol such as Transmission Control Protocol and/or the Internet Protocol (TCP/IP) protocol in one embodiment. Alternatively or additionally, other suitable protocols for providing video data and/or signals to the display panels 304 may be used. For example, data controller may provide video data to the display panels 304 using a High-Definition Multimedia Interface (HDMI), composite video interface, S-video interface, component video interface, and the like. In other embodiments, the communication may be performed using a secure protocol such as Secure Shell (SSH) and/or may be encrypted using other encryption protocols and algorithms.

Having discussed several examples of a multi-panel display system that may be used in providing and/or implementing various aspects of the disclosure, a number of embodiments will now be discussed in greater detail. In particular, and as introduced above, some aspects of the disclosure generally relate to operating a display panel in a multi-panel display system if or when a power supply in the display panel has failed. In the description below, various examples illustrating how a display panel may operate in accordance with one or more embodiments will be discussed.

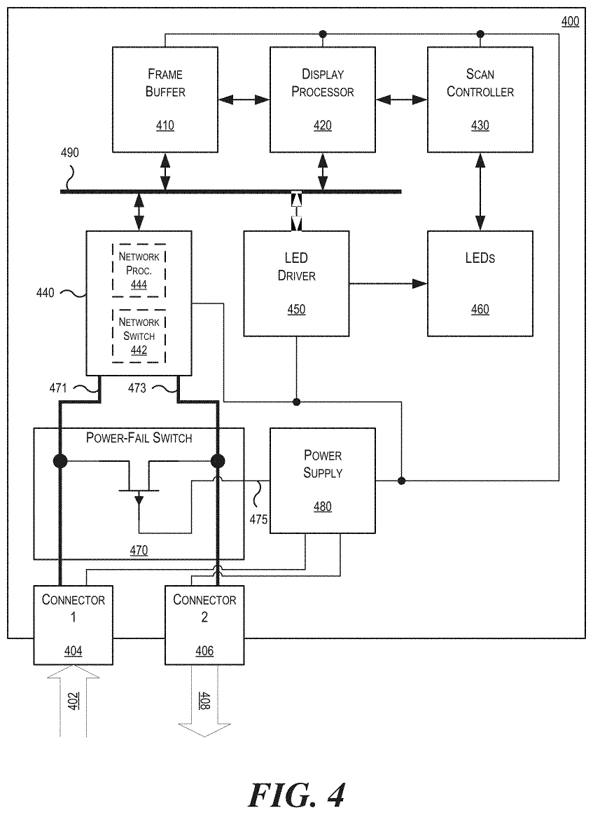

FIG. 4 depicts an illustrative architecture of a display panel for a multi-panel display system in accordance with one or more embodiments. The display panel 400 may be similar or identical to the display panels described in the previous figures (i.e., FIGS. 1-3) and may include additional features not mentioned above. Display panel 400 may provide a path for incoming data from a previous display panel to pass-through the display panel 400 to a next display panel if or when a power supply in the display panel has failed.

Display panel 400 may comprise a first connector 404 and a second connector 406. First connector 404 may provide a connection point between display panel 400 and a previous display panel 402. A previous display panel 402 may be another display panel 400 that is connected “upstream”, or closer to the power and/or data source as the instant display panel 400, as described in FIGS. 3A-3B. Display panel 400 may depend upon previous display panel 402 for receiving power and data signals. It is understood that the connection point may be provided in various ways. Those of skill in the art will appreciate that the connection point may be jacks configured to receive corresponding plugs. In another embodiment, a cable may extend from the previous display panel 402 with a connector (e.g., a jack or a plug) affixed to the external end of the cable to provide an interface for the first connector 404. While FIG. 4 depicts first connector 404 as a single connector, it is understood that this is for illustration purposes only. For example, first connector 404 may comprise multiple connectors, such as separate connectors for power signals and for data signals. In other embodiments, first connector 404 may comprise a single connector with data and power signals combined.

Second connector 406 may provide a connection point between display panel 400 and a next display panel 408. A next display panel 408 may be another display panel 400 that is connected “downstream”, or further away from the power and/or data source as the instant display panel 400, as described in FIGS. 3A-3B. Next display panel 408 may depend on display panel 400 for receiving power and data signals. It is understood that the connection point may be provided in various ways. Those of skill in the art will appreciate that the connection point may be jacks configured to receive corresponding plugs. In another embodiment, a cable may extend from the next display panel 408 with a connector (e.g., a jack or a plug) affixed to the external end of the cable to provide an interface for the second connector 406. While FIG. 4 depicts second connector 406 as a single connector, it is understood that this is for illustration purposes only. For example, second connector 406 may comprise multiple connectors, such as separate connectors for power signals and for data signals. In other embodiments, second connector 406 may comprise a single connector with data and power signals combined.

In some embodiments, first connector 404 may be considered as an “input” connector since it may provide a connection for receiving power signals and data signals from a previous display panel 402. Similarly, second connector 406 may be considered as an “output” connector since it may provide and/or pass-through power signals and data signals to a next display panel 408.

Power signals from first connector 404 may be coupled to a power supply 480 as depicted in FIG. 4. In some embodiments, the power supply 480 may regulate the incoming power signals. In other embodiments, power supply 480 may also convert incoming alternating current (AC) signals into direct current (DC) signals that may be used to power the circuitry (e.g., frame buffer 410, display processor 420, scan controller 430, network interface 440, and LED driver 450) in the display panel 400. In some embodiments, power signals from first connector 404 may be coupled to the power supply 480 and power supply 480 may provide a pass-through power connection to second connector 406. In other embodiments, power signals from first connector 404 may be coupled to second connector 406 to pass through some of the received power to the next display panel 408.

As depicted in FIG. 4, power supply 480 may provide a common voltage level and power level to the components comprised by display panel 400 (e.g., frame buffer 410, display processor 420, scan controller 430, network interface 440, and LED driver 450.) However, in some embodiments, power supply 480 may provide distinct voltage levels and/or power levels to different components within display panel 400. For example, power supply 480 may provide a higher voltage level and power level to LED driver 450 which may be required for LED driver to power the LEDs 460. Additionally or alternatively, power supply 480 may provide a lower voltage level and power level to frame buffer 410, display processor 420, scan controller 430, and/or network interface 440. In yet other embodiments, power supply 480 may provide a different voltage level and/or power level to each component of display panel 400.

Power supply 480 may provide a logic signal 475 that may indicate to the power-fail switch 470 whether the power supply is active or whether it has failed. For example, logic signal 475 may be active, or true, if or when the power supply is providing power to the circuitry in the display panel 400. The logic signal 475 may be inactive, or false, if or when the power supply fails to provide power to the rest of display panel 400.

In various embodiments, the display panel 400 includes a bypass circuit that is configured to forward the received data to an adjacent modular display when the power supply 480 fails, e.g., does not generate the supply voltage to power the LEDs. In one or more embodiments, the bypass circuit may include a power-fail switch 470.

First data signals 471 from first connector 404 and second data signals 473 from second connector 406 may be coupled to power-fail switch 470. In some embodiments, first data signals 471 and second data signals 473 may also be coupled to network interface 440.

Power-fail switch 470 may comprise an “always on” transistor such as a junction gate field-effect transistor (JFET), a depletion mode Metal Oxide Semiconductor Field Effect Transistor (MOSFET) (normally ON transistor), which may be a high electron mobility transistor (HEMT) in one embodiment.

The power-fail switch 470 may be configured to act as an open circuit if or when the power supply 480 is active, i.e. if or when logic signal 475 is active and/or true. In such scenarios, first data signals 471 may travel from first connector 404 to network interface 440 and second data signals 473 may travel from network interface 440 to second connector 406. The power-fail switch 470 may be further configured to act as a closed circuit, or short, if or when the power supply 480 has failed, i.e. if or when logic signal 475 is inactive and/or false. In such scenarios, first data signals 471 may travel from first connector 404 to second connector 406, and bypass network interface 440, which may no longer be operational because it may no longer be receiving power from power supply 480. In this manner, display panel 400, via the power-fail switch 470, may provide a path for incoming data from a previous display panel 402 to pass-through the display panel 400 to a next display panel 408 if or when a power supply 480 in the display panel 400 has failed.

Network interface 440 may receive the first data signals 471 from first connector 404. The network interface 440 may comprise a network switch in one embodiment. In some embodiments, the network interface 440 may identify data to be used by the display panel 400 and may also forward all incoming data on to next display panel 408 via the second connector 406. In such embodiments, the next display panel 408 and other display panels may identify the information that may be relevant to that particular panel from the received data. In other embodiments, network interface 440 may remove the data to be used by the display panel 400 and selectively send the remaining data on to next display panel 408 via the second connector 406. For example, network interface 440 may only forward data corresponding to other display panels to the next display panel 408 rather than forwarding all received data. If or when power supply 480 fails to provide power to the network interface 440, the network interface 440 may stop identifying data for use by display panel 400 and may also stop forwarding data to second connector 406.

The network interface 440 may provide received data to a display processor 420. Network interface 440 may provide the received data via data bus 49o. In some embodiments, network interface 440 may provide all received data to display processor 420. For example, display processor 420 may decode the received data to identify portions of the data that may be addressed to the display panel 400 or that may be displayed by the display panel 400. In other embodiments, network interface 440 may provide to the display processor 420 only the portion of the received data that may be addressed to the display panel 400. For example, network interface 440 may decode the received data to identify portions of the data that may be addressed to the display panel 400 or that may be displayed by the display panel 400. The display processor may use the frame buffer 410 as needed to store received data during processing. Alternatively or additionally, network interface 440 may provide the received data to display processor 420 by causing the received data to be stored in frame buffer 410.

Network interface 440 may comprise a network switch 442 that may forward all incoming data packets to the alternate data connection. For example, network switch 442 may forward all data packets received via data signal path 471 to data signal path 473 and may also forward all data packets received via data signal path 473 to data signal path 471. Additionally or alternatively, network switch 442 may forward data packets received via data signal path 471 and via data signal path 473 to a display processor 420. Display processor 420 may decode the received data packets to identify at least one of the data packets that may be addressed to the display panel 400 or that may be displayed by the display panel 400. In other embodiments, network switch 442 may examine the received data packets and identify a portion of the data packets that may be addressed to the display panel 400 or that may be displayed by the display panel 400. In such scenarios, network switch may forward only the identified portion of the data packets to the display processor 420. Additionally or alternatively, network switch 442 may refrain from forwarding the identified portion of the data packets via the alternate data connection. In other words, network switch 442 may not forward to other display panels the portion of the data packets identified to be addressed to the instant display panel 400.

In yet other embodiments, network interface 440 may further comprise a network stack processor 444. Network stack processor may examine the data packets received by network switch 442, and, based on the examination, determine whether the data packets are addressed to display panel 400 or contain data to be displayed by the display panel 400. If or when network stack processor 444 may determine that a received data packet is addressed to display panel 400, network stack processor 444 may cause the received data packet to be forwarded to display processor 420. For example, network stack processor 444 may cause the received packet to be stored in frame buffer 410. Alternatively or additionally, network stack 444 may further cause network switch 442 to not forward the received data packet. In other embodiments, network stack processor 444 may allow all received data packets to be forwarded via the alternate data port. In such scenarios, network stack processor 444 may allow network switch 442 to forward all data packets received via data signal path 471 to data signal path 473 and may also allow network switch 442 to forward all data packets received via data signal path 473 to data signal path 471.

Display panel 400 may also comprise a scan controller 430. Scan controller 430, which may also comprise an address decoder (not shown), may obtain the media to be displayed. Scan controller 430 may process the media to be displayed and may identify individual LEDs in the LEDs 460 that may need to be controlled. For example, scan controller 430 may determine, for each LED in the LEDs 460, color, brightness, refresh time, and other associated control parameters to display the media. In some embodiments, scan controller 430 may provide the control parameters to LED driver 450. LED driver 450 may use the provided control parameters to determine appropriate current, voltage, and timing parameters for each LED in the LEDs 460. In other embodiments, scan controller 430 may be coupled with LEDs 460. For example, in such a scenario, LED driver 450 may provide a constant current to LEDs 460 and scan controller 430 may control if or when to turn on or off a particular LED of LEDs 460. Alternatively or additionally, scan controller 430 may be integrated into LED driver 450.

FIG. 4 illustrates just one example of an architecture for a display panel with a power-fail switch, and those of skill in the art will appreciate that the specific power-fail switch architecture used may vary, and is secondary to the functionality that it may provide, as described further herein. For example, the functionality provided by a power-fail switch may also be provided by a transmission gate based on JFETs, or by mechanical and/or solid-state relays, or other similar components.

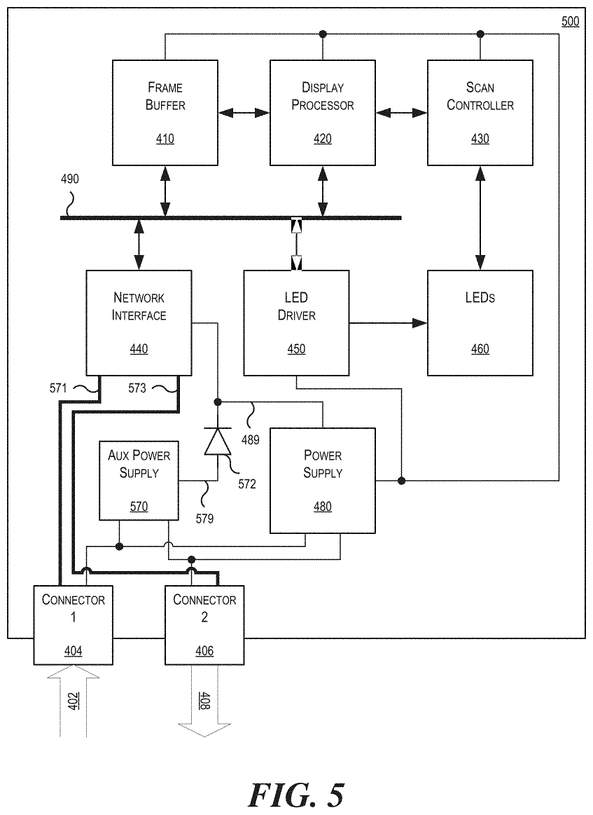

FIG. 5 depicts another illustrative architecture of a display panel for a multi-panel display system in accordance with one or more embodiments. The display panel 500 may be similar to the display panels described in the previous figures (i.e., FIGS. 1-4) and may include additional features not mentioned above. For example, with similar numerals representing similar features in FIG. 4, display panel 500 may replace power-fail switch 470 with an auxiliary power supply 570 that may provide power to network interface 440 if or when a power supply 480 in the display panel 500 has failed. Accordingly in this embodiment, the display panel 500 includes a bypass circuit that includes an auxiliary power supply 570.

In some embodiments, auxiliary power supply 570 may be coupled to first power signals from first connector 404. Auxiliary power supply 570 may utilize the first power signals from first connector 404 to generate power for network interface 440. In other embodiments, auxiliary power supply 570 may be coupled to second power signals from second connector 406 and may use the second power signals to generate power for network interface 440. In yet other embodiments, auxiliary power supply 570 may be coupled to both the first power signals from first connector 404 and to the second power signals from second connector 406. In such scenarios, auxiliary power supply 570 may use either the first power signals or the second power signals to generate power for network interface 440. Auxiliary power supply 570 may comprise a low-dropout (LDO) regulator and/or a linear regulator that may convert the first power signals and/or the second power signals to a voltage level and a power level that may be appropriate for powering the network interface 440. Auxiliary power supply 570 may be coupled to network interface 440 via a blocking diode 572. Under normal operation, power supply 480 may provide power to network interface 440 via signal path 489. The voltage provided by power supply 480 to network interface 440 may be higher than a voltage provided by auxiliary power supply 570 at signal path 579. The voltage difference may cause a reverse bias across blocking diode 572 which may result in network interface 440 receiving the power from power supply 480 and not from auxiliary power supply 570. If or when power supply 480 fails, blocking diode 572 may allow the power generated by auxiliary power supply 570 to reach network interface 440. In such scenarios, network interface 440 may continue to receive data signals 571 from first connector 404 and forward the data signals to second connector 406 via signal path 573. In this manner, display panel 500 may provide a path for incoming data from a previous display panel 402 to pass-through the display panel 500 to a next display panel 408 if or when a power supply 480 in the display panel 500 has failed. Although a blocking diode is used to show the above functionality, in other embodiments, other equivalent components including transistors may be used to achieve a similar functionality. For example, a control circuit may be used to switch between the power received from the power supply 480 and the auxiliary power supply 570. This control circuit may be powered by the auxiliary power supply 570.

FIG. 5 illustrates just one example of an architecture for a display panel 500 with an auxiliary power supply 570, and those of skill in the art will appreciate that the specific architecture for the auxiliary power supply 570 may vary, and is secondary to the functionality that it may provide, as described further herein. For example, the auxiliary power supply 570 may also comprise a non-isolated power converter (e.g., step-down DC/DC converter) and/or an isolated power converter (e.g., full-bridge DC/DC converter), or other similar components.

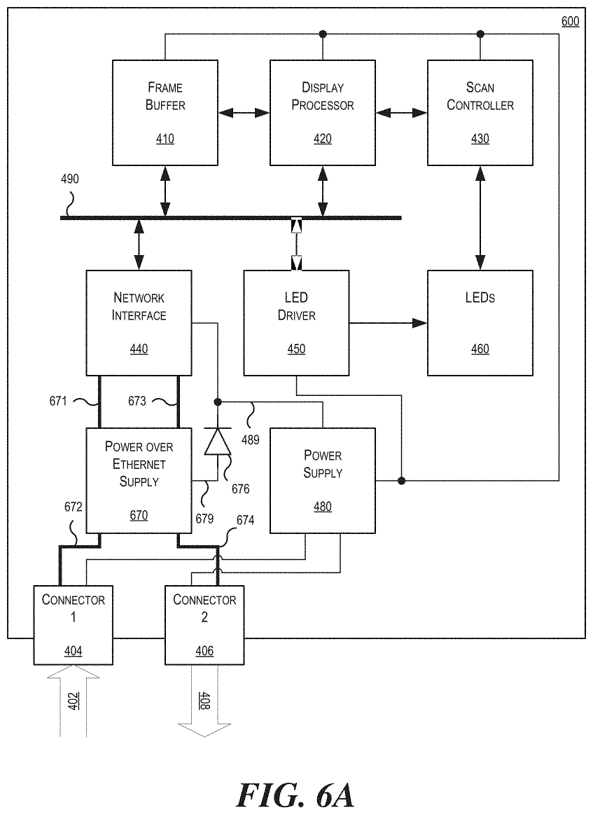

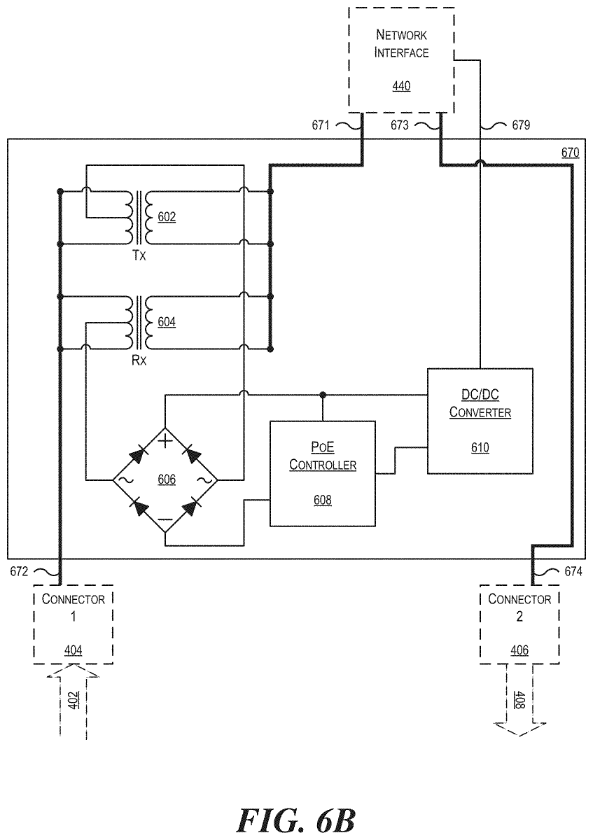

FIGS. 6A and 6B depict another illustrative architecture of a display panel for a multi-panel display system in accordance with one or more embodiments. The display panel 600 may be similar to the display panels described in the previous figures (i.e., FIGS. 1-5) and may include additional features not mentioned above. For example, with similar numerals representing similar features in FIG. 4, display panel 600 may replace power-fail switch 470 with a Power-Over-Ethernet (PoE) power supply 670 that may provide power to network interface 440 if or when a power supply 480 in the display panel 600 has failed. Advantageously, because the power required to operate the network switch within the network interface 440 is smaller than the power required to operate the panels, a low voltage signal can be sufficient to power the network switch. For example, a low voltage AC, e.g., 5V AC, can be transmitted with the PoE cable. The use of low voltage also reduces the hardware requirement of the auxiliary power supply 570.

In some embodiments, PoE power supply 670 may be coupled to first data signals from first connector 404. PoE power supply 670 may utilize the first data signals from first connector 404 to generate power for network interface 440. In other embodiments, PoE power supply 670 may be coupled to second data signals from second connector 406 and may use the second data signals to generate power for network interface 440. In yet other embodiments, PoE power supply 670 may be coupled to both the first data signals from first connector 404 and to the second data signals from second connector 406. In such scenarios, PoE power supply 670 may use either the first data signals or the second data signals to generate power for network interface 440.

Referring to FIG. 6B, a representative schematic of a PoE power supply is displayed. PoE power supply 670 may comprise a transmit transformer 602, a receive transformer 604, a bridge rectifier 606, a PoE controller 608, and a DC/DC converter 610. In the present embodiment, PoE power supply 670 may be connected to the transmit and receive pairs of the data signals from the first connector 672. The incoming data signals 672 may then be forwarded to network interface 440 as data signals 671 after passing through transmit transformer 602 and receive transformer 604. Outgoing data signals 673 from network interface 440 may be coupled to second connector 406 and not used by PoE power supply 670. In other embodiments, PoE power supply 670 may draw power from second data signals 674 from second connector 406 and pass-through first data signals 672. For example, transmit transformer 602 and receive transformer 604 may be connected to second data signals 674. In yet other embodiments, PoE power supply 670 may draw power from both the first data signals 672 and from second data signals 674. The output of transmit transformer 602 and receive transformer 604 may be coupled to a PoE controller 608 and to a DC/DC converter 610 via bridge rectifier 606. The PoE controller 608 and the DC/DC converter 610 may condition the provided power signal and convert it to a voltage level appropriate for a network interface 440. In the present embodiment, network interface 440 may receive its power from PoE power supply 670. In other embodiments, and similar to the functionality described in FIG. 5, PoE power supply 670 and power supply 480 may both be connected to network interface 440. In such a scenario, PoE power supply 670 may be coupled to network interface 440 via a blocking diode 676, such that PoE power supply 670 may supply power to network interface 440 if or when power supply 480 has failed. In this manner, display panel 600 may provide a path for incoming data from a previous display panel 402 to pass-through the display panel 600 to a next display panel 408 if or when a power supply 480 in the display panel 600 has failed. Accordingly, in this embodiment, the bypass circuit includes a PoE power supply 670 and the blocking diode 676.

FIGS. 6A-6B illustrate just one example of an architecture for a display panel 500 with a PoE power supply 670, and those of skill in the art will appreciate that the specific architecture for the PoE power supply 670 may vary, and is secondary to the functionality that it may provide, as described further herein. For example, the PoE controller 608 and DC/DC converter 610 may be combined into a single component.

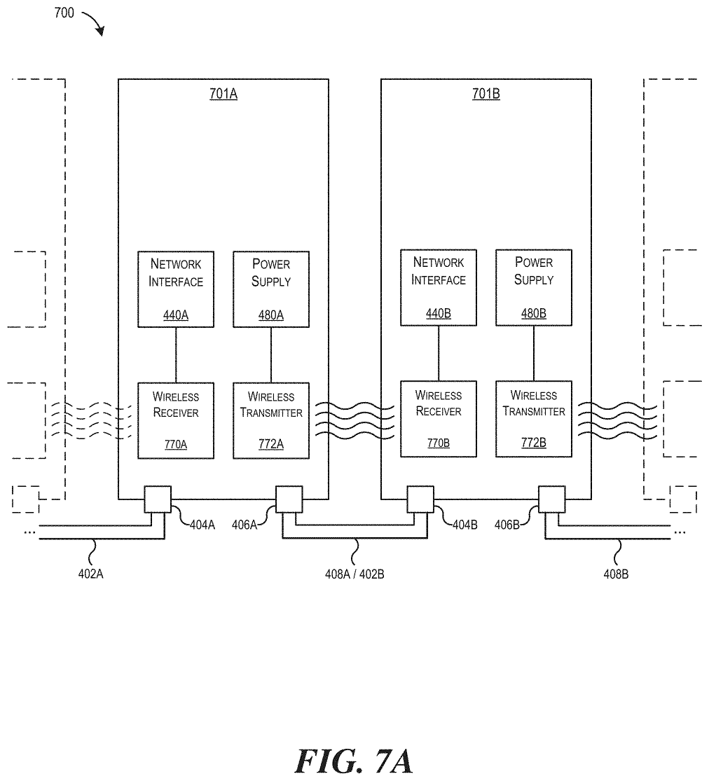

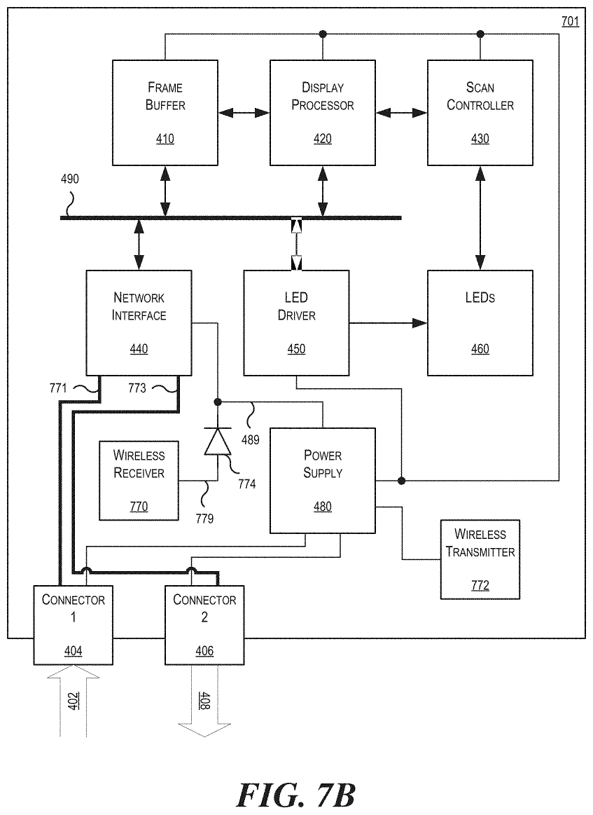

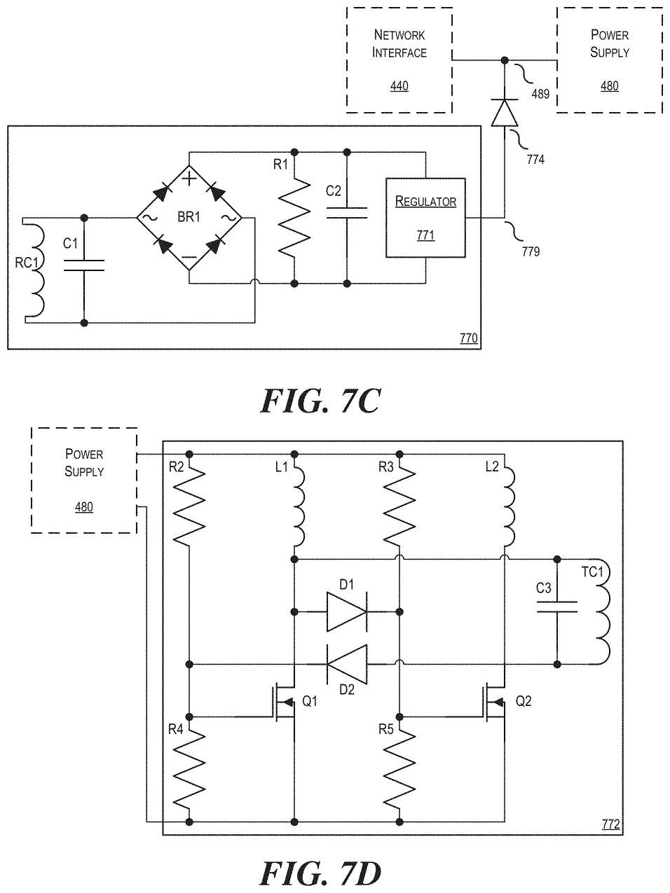

FIGS. 7A-7C depict another illustrative architecture of a display panel for a multi-panel display system in accordance with one or more embodiments. Multi-panel display system 700 may be similar or identical to the multi-panel display systems described in FIGS. 1 and 3, and may include additional features not mentioned above. Similarly, the display panel 701 may be similar to the display panels described in the previous figures (i.e., FIGS. 1-6) and may include additional features not mentioned above. For example, with similar numerals representing similar features in FIG. 4, display panel 701 may replace power-fail switch 470 with a wireless power receiver 770 and a wireless power transmitter 772 that may provide power to network interface 440 if or when a power supply 480 in the display panel 701 has failed.

As shown in FIG. 7A, display panel 701A may be connected to a previous display panel (not shown) via connector 404A and connection 402A and may be connected to a next display panel 701B via connector 406A and connection 408A. Similarly, display panel 701B may be connected to a previous display panel 701A via connector 404B and connection 402B and may be connected to a next display panel (not shown) via connector 406B and connection 408B.

Display panel 701B may comprise a wireless power receiver 770B that may be wirelessly coupled to a wireless power transmitter 772A in a previous display panel 701A. Wireless power receiver 770B may be connected to network interface 440B and may provide power to network interface 440B. For example, wireless power receiver 770B may receive power wirelessly from a wireless power transmitter 772A in a previous display panel 701. In such a scenario, wireless power receiver 770B may provide power to network interface 440B if or when power supply 480B has failed.

Depending on the received power, other components of the display panel 701 may also be powered in some embodiments. For example, a health monitoring circuit may be powered so as to communicate and provide a detailed report of the power loss problem to a remote monitoring computer.

Display panel 701A may also comprise a wireless power transmitter 772A that may be wirelessly coupled to wireless power receiver 770B and may provide power to it. Wireless power transmitter 772A may be powered by power supply 480A and may be configured to be powered when the power of an adjacent panel, e.g., power supply 480B, fails. Accordingly, in this embodiment, the bypass circuit includes a wireless power receiver 770 and a wireless power transmitter 772.

FIG. 7B shows a detailed architecture diagram for a display panel 701 that may be used in the multi-panel display system 700 described in FIG. 7A. First data signals 771 from first connector 404 and second data signals 773 from second connector 406 may be coupled to network interface 440. Wireless power receiver 770 may be coupled to network interface 440 via a blocking diode 774. Under normal operation, power supply 480 may provide power to network interface 440 via signal path 489. The voltage provided by power supply 480 to network interface 440 may be higher than a voltage provided by wireless power receiver 770 at signal path 779. The voltage difference may cause a reverse bias across blocking diode 774 which may result in network interface 440 receiving the power from power supply 480 and not from wireless power receiver 770. If or when power supply 480 fails, blocking diode 774 may allow the power generated by wireless power receiver 770 to reach network interface 440. Wireless power receiver 770 may generate power from power received wirelessly from a previous display panel 420. In such scenarios, network interface 440 may continue to receive first data signals 771 from first connector 404 and forward the data signals to second connector 406 via signal path 773. In this manner, display panel 701 may provide a path for incoming data from a previous display panel 402 to pass-through the display panel 701 to a next display panel 408 if or when a power supply 480 in the display panel 701 has failed.

An illustrative schematic for a wireless power receiver 770 is shown in FIG. 7C. Wireless power receiver 770 may be configured to receive a voltage wirelessly from a wireless power transmitter 772 of a previous display panel 701. In other embodiments, wireless power receiver 770 may receive a voltage wirelessly from a wireless power transmitter 772 of a next display panel 701. Wireless power receiver 770 may comprise a receiver coil RC1, a rectifier circuit (i.e., elements C1 and BR1), and a regulator 771. If or when the receiver coil RC1 is placed at a distance near wireless power transmitter 772, an AC power may be induced in the receiver coil RC1. The AC power may be rectified by the rectifier circuit and regulated to an appropriate voltage level (e.g., 5V DC) by the regulator 771. In some embodiments, the output 779 of the regulator 771 may be coupled to network interface 440 via a blocking diode 774. As described before, the blocking diode 774 switch from allowing power from power supply 480 to flow to the network interface 440 during normal operations, and allow power from the wireless power receiver 770 to flow to the network interface 440 if or when the power supply 480 has failed. In some embodiments, the output 770 from wireless power receiver 770 may be coupled directly to network interface 440. In such scenarios, network interface 440 may be powered by the wireless power receiver 770 during both normal operations and if or when power supply 480 has failed.

Referring to FIG. 7D, an example architecture for a wireless power transmitter 772 is shown. Wireless power transmitter 772 may be configured to produce a voltage wirelessly in the wireless power receiver 770 of a next display panel 701. In other embodiments, wireless power transmitter 772 may be configured to produce a voltage wirelessly in the wireless power receiver 770 of a previous display panel 701. Wireless power transmitter 772 may comprise an oscillator circuit (i.e., R2, R3, R4, R5, L1, L2, D1, D2, Q1, and Q2), a tank circuit (i.e., C3), and a transmitter coil TC1. Power supply 480 may provide a DC voltage to wireless power transmitter 772. The applied DC power may cause an alternating current to flow through the tank circuit C3 and the transmitter coil TC1, which may in turn induce a voltage in a wireless power receiver 770 that is inductively coupled to the wireless power transmitter 772.

FIGS. 7A-7D illustrate just one example of an architecture for a display panel 701 with a wireless power receiver 770 and a wireless power transmitter 702, and those of skill in the art will appreciate that the specific architecture for the wireless power receiver 770 and the wireless power transmitter 702 may vary, and is secondary to the functionality that it may provide, as described further herein.

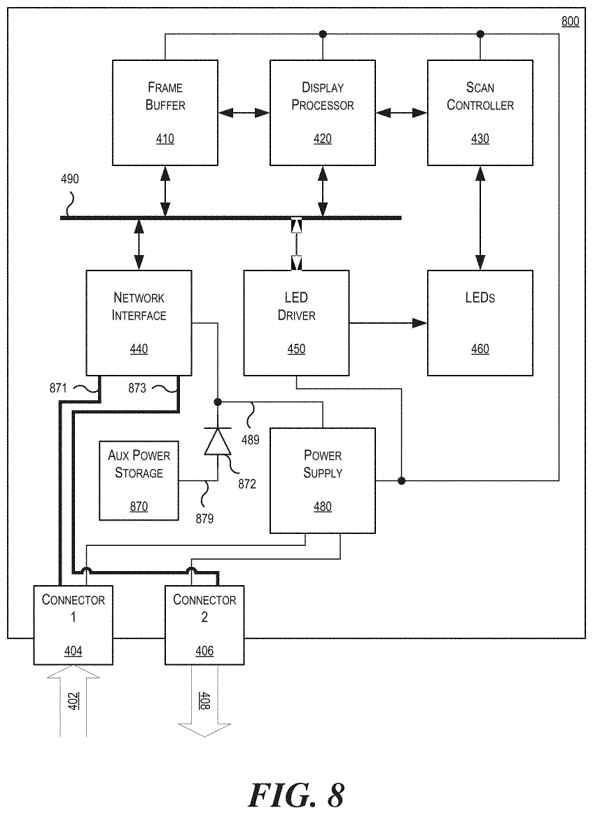

FIG. 8 depicts another illustrative architecture of a display panel for a multi-panel display system in accordance with one or more embodiments. The display panel 800 may be similar to the display panels described in the previous figures (i.e., FIGS. 1-7) and may include additional features not mentioned above. For example, with similar numerals representing similar features in FIG. 4, display panel 800 may replace power-fail switch 470 with an auxiliary power storage 870 that may provide power to network interface 440 if or when a power supply 480 in the display panel 800 has failed.

In some embodiments, auxiliary power storage 870 may comprise a battery that may provide power to network interface 440 if or when a power supply 480 in the display panel 800 has failed. In other embodiments, auxiliary power storage 870 may comprise a rechargeable battery. In such scenarios, the rechargeable battery comprised by auxiliary power storage 870 may be recharged any number of possible methods. For example, power supply 480 may provide power to the rechargeable battery. In another example, an auxiliary power supply similar to the auxiliary power supply described in FIG. 5 may be used to recharge the battery. In other examples, a PoE power supply similar to the one described with respect to FIG. 6 may also be used to recharge the battery. In yet other examples, a wireless power receiver and wireless power transmitter similar to those described in FIG. 7 may be used to maintain the rechargeable battery in a charged state.

Continuing to refer to FIG. 8, auxiliary power storage 870 may be coupled to network interface 440 via a blocking diode 872. Under normal operation, power supply 480 may provide power to network interface 440 via signal path 489. The voltage provided by power supply 480 to network interface 440 may be higher than a voltage provided by auxiliary power storage 870 at signal path 879. The voltage difference may cause a reverse bias across blocking diode 872 which may result in network interface 440 receiving the power from power supply 480 and not from auxiliary power storage 870. If or when power supply 480 fails, blocking diode 872 may allow the power generated by auxiliary power storage 870 to reach network interface 440. In such scenarios, network interface 440 may continue to receive data signals 871 from first connector 404 and forward the data signals to second connector 406 via signal path 873. In this manner, display panel 800 may provide a path for incoming data from a previous display panel 402 to pass-through the display panel 800 to a next display panel 408 if or when a power supply 480 in the display panel 800 has failed. In other embodiments, the output 879 from auxiliary power storage 870 may be coupled directly to network interface 440. In such scenarios, network interface 440 may be powered by the auxiliary power storage 870 during both normal operations and if or when power supply 480 has failed.

Accordingly, in this embodiment, the bypass circuit includes the auxiliary power storage 870 and the associated circuitry including control circuit or blocking diode 872.

FIG. 8 illustrates just one example of an architecture for a display panel 800 with an auxiliary power storage 870, and those of skill in the art will appreciate that the specific architecture for the auxiliary power storage 870 may vary, and is secondary to the functionality that it may provide, as described further herein. For example, the auxiliary power storage 870 may also comprise a super capacitor, or other similar components.

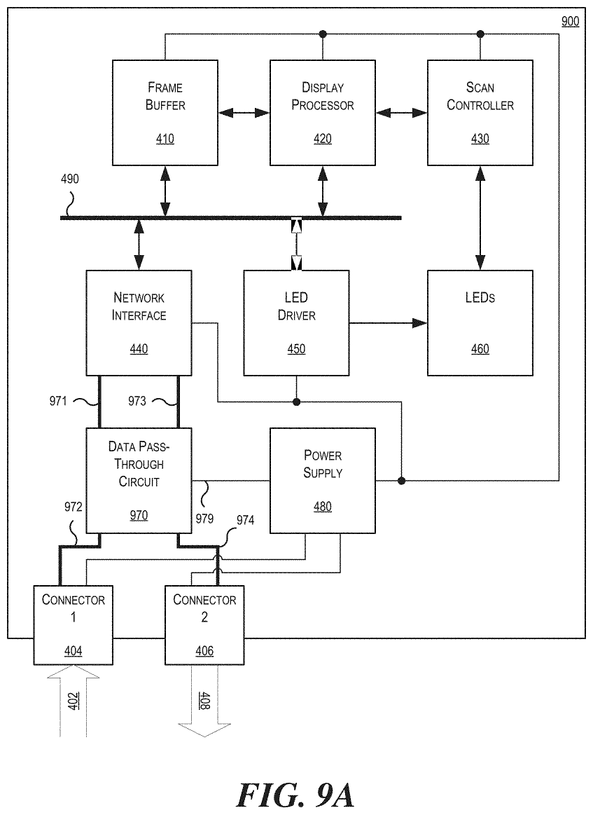

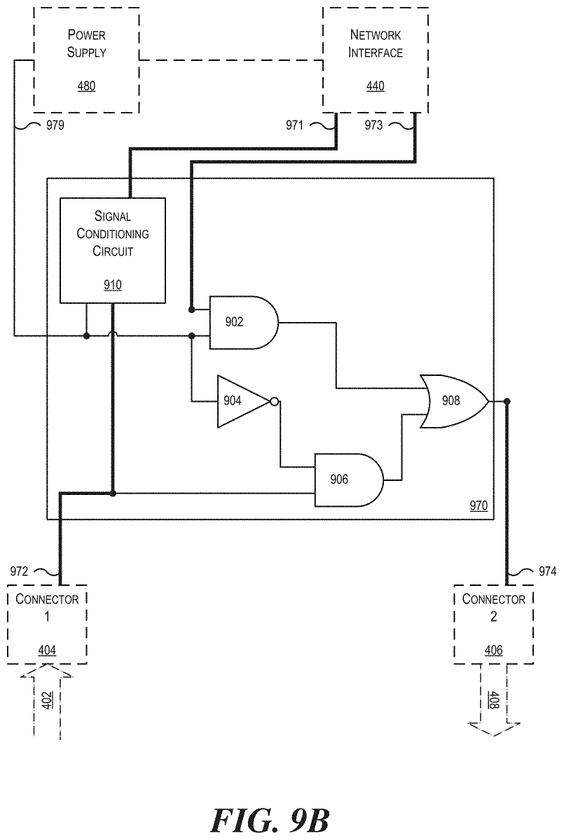

FIGS. 9A and 9B depict another illustrative architecture of a display panel for a multi-panel display system in accordance with one or more embodiments. The display panel 900 may be similar to the display panels described in the previous figures (i.e., FIGS. 1-8) and may include additional features not mentioned above. For example, with similar numerals representing similar features in FIG. 4, display panel 900 may provide a path for first data signals 972 from a previous display panel 402 to pass-through the display panel 900 to a next display panel 408 if or when a power supply 480 in the display panel 900 has failed.

As shown in FIG. 9A, data pass-through circuit 970 may utilize the logic signal 979 provided by power supply 480 to switch from providing outgoing data signal 973, from network switch 440, to second connector 406 via signal path 974 to providing incoming data signal 972 to second connector 406 via signal path 974. As will be described in further detail below, data pass-through circuit 970 may pass-through incoming data signal 972 to next display panel 408 if or when power supply 480 has failed. In some embodiments, data pass-through circuit 970 may be powered by an auxiliary power supply similar to the auxiliary power supply described in FIG. 5. In other embodiments, a PoE power supply similar to the one described with respect to FIG. 6 may also be used to power data pass-through circuit 970. In yet other embodiments, a wireless power receiver and wireless power transmitter similar to those depicted in FIG. 7 may be used to power data pass-through circuit 970. In yet other embodiments, the auxiliary power storage 870 as described in FIG. 8 may be used to power data-pass through circuit 970. In this manner, display panel 900, via the data pass-through circuit 970, may provide a path for first data signals 972 from first connector 404 from a previous display panel 402 to pass-through the display panel 900 to a next display panel 408 if or when a power supply 480 in the display panel 900 has failed. Accordingly, in this embodiment, the bypass circuit includes the data pass-through circuit 970.

Referring to FIG. 9B, an illustrative schematic diagram of an exemplary data pass-through circuit 970 that may be used with a display panel 900 is depicted. Data pass-through circuit 970 may receive incoming data signals 972 from first connector 404, outgoing data signals 973 from network interface 440, and logic signal 979 from power supply 480. Alternatively or additionally, data pass-through circuit 970 may provide data signals to network interface 440 via signal path 971 and data signals 974 to second connector 406.

In the present implementation, data pass-through circuit 970 may comprise a signal conditioning circuit 910, an AND gate 902, an inverter 904, an AND gate 906, and an OR gate 908. Signal conditioning circuit 910 may regulate signal levels of the incoming data signals 972. For example, signal conditioning circuit 910 may measure an average peak amplitude of the incoming data signals 972. If or when, the measured average peak amplitude of the incoming data signals 972 does not meet a predetermined threshold range, the signal conditioning circuit 910 may apply a gain to the incoming data signals 972 to bring the average peak amplitude of the incoming data signals 972 within the predetermined threshold range. For example, if or when the average peak amplitude may be lower than the predetermined threshold range, the signal conditioning circuit 910 may amplify, or increase the gain on, the incoming data signals 972. Conversely, if or when the average peak amplitude may be higher than the predetermined threshold range, the signal conditioning circuit 910 may de-amplify, or reduce the gain on, the incoming data signals 972. In other embodiments, the average peak amplitude may be within the predetermined threshold range and the signal conditioning circuit 910 may leave the incoming data signals 972 unaffected. The signal conditioning circuit 910 may provide the conditioned data signals to network interface 440. If or when power supply 480 fails to provide power (i.e., logic signal 979 is inactive or LOW), the signal conditioning circuit 910 may cease to condition the incoming data signals 972 and to provide the incoming data signals 972 to network interface 440.

Data pass-through circuit 970 may utilize the logic signal 979 to switch between providing incoming data signal 972 or providing outgoing data signal 973 to second connector 406 via signal path 974. For example, logic signal 979 may be active, or HIGH, if or when power supply 480 is active and providing power to components of display panel 900. Logic signal 979 may be inactive, or LOW, if or when the power supply 480 has failed. A logic signal 979 in a HIGH state may turn on AND gate 902 and cause its output to equal that of outgoing data signal 973. The HIGH state of logic signal 979 may be turned into a LOW by inverter 904 and may be provided to AND gate 906, which may cause AND gate 906 to turn off and output LOW regardless of the values of incoming data signal 972. OR gate 908 may combine the outputs of the two AND gates (i.e., 902 and 906), and may result in the output 974 of data pass-through circuit 970 to match the values of outgoing data signal 973. Similarly, if or when logic signal 979 may be inactive, or LOW, the output of data pass-through circuit 970 may match the values of incoming data signal 972. Although not shown for the sake of simplicity, decision logic circuit 500 may also comprise additional components (e.g., buffers, inverters, etc.) which may balance propagation delays across all data paths in the circuit, and thus may avoid synchronization problems such as glitching, blanking, and the like. In addition, in some embodiments, incoming data signals 972, outgoing data signals 973, and signal path 974 may comprise multiple signals over multiple individual wires. For example, if or when data signals are transmitted over Cat 5 cable using Ethernet protocol. In such a scenario, data signals may comprise up to four twisted cable pairs. It is understood that in such scenarios, the schematic depicted in FIG. 9B may be repeated for each individual cable comprising data signals. It is also understood that the illustrative embodiment described in FIG. 9B is for illustration purposes only. Those of skill in the art will appreciate that the schematic of the data pass-through circuit 970 may vary, and is secondary to the functionality that it provides, as further described herein.

FIGS. 9A and 9B illustrate just one example of an architecture for a display panel 900 with a data pass-through circuit 970, and those of skill in the art will appreciate that the specific architecture for the data pass-through circuit 970 may vary, and is secondary to the functionality that it may provide, as described further herein. For example, the data pass-through circuit 970 may be incorporated into network interface 440.

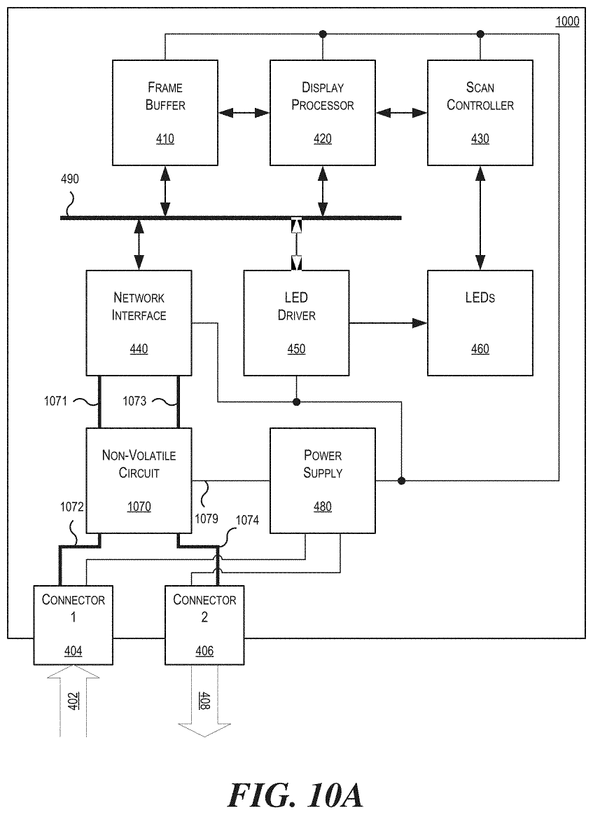

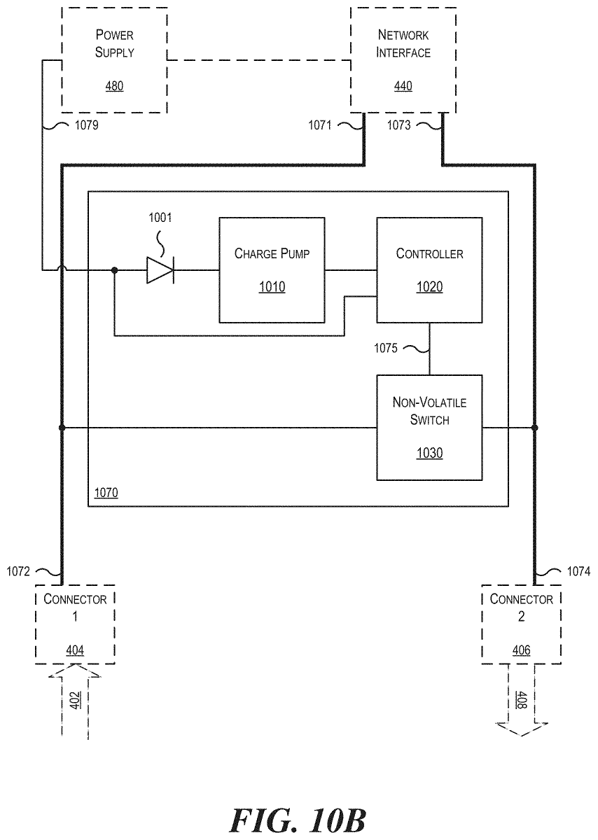

FIGS. 10A and 10B depict another illustrative architecture of a display panel for a multi-panel display system in accordance with one or more embodiments. The display panel woo may be similar to the display panels described in the previous figures (i.e., FIGS. 1-9) and may include additional features not mentioned above. For example, with similar numerals representing similar features in FIG. 4, display panel woo may replace power-fail switch 470 with a non-volatile circuit 1070 that may provide a path for first data signals 1072 from a previous display panel 402 to pass-through the display panel woo to a next display panel 408 if or when a power supply 480 in the display panel woo has failed.

As shown in FIG. 10A, non-volatile circuit 1070 may utilize the power signal 1079 provided by power supply 480 to switch from providing outgoing data signal 1073, from network switch 440, to second connector 406 via signal path 1074 to providing incoming data signal 1072 to second connector 406 via signal path 974. As will be described in further detail below, non-volatile circuit 1070 may pass-through incoming data signal 1072 to next display panel 408 if or when power supply 480 has failed. Accordingly, in this embodiment, the bypass circuit includes the non-volatile circuit 1070.

An illustrative schematic diagram of an exemplary non-volatile circuit 1070 that may be used with a display panel woo is depicted in FIG. 10B. Incoming data signals 1072 from first connector 404 may be coupled to both a non-volatile switch 1030 and to network interface 440. Outgoing data signals 973 from network interface 440 may be coupled to non-volatile switch 1030 and to second connector 406 via signal path 1074. Power supply 480 may provide power signal 1079 to charge pump 1010 and to controller 1020. Charge pump 1010 may store charge provided power signal 1079. Charge pump low may be coupled to power supply 480 via a blocking diode 1001 that may prevent the charge pump 1010 from draining its charge towards the power supply 480. Controller 1020 may compare the provided power signal 1079 with an internally-generated reference signal to determine if or when the power supply 480 has failed. For example, controller 1020 may utilize a Zener diode and/or a comparator (not shown) to determine if power signal 1079 is lower than a reference voltage level. If or when power signal 1079 is higher than a reference voltage level, controller 1020 may determine that power supply 480 has not failed. If or when power signal 1079 is lower than the reference voltage level, controller 1020 may determine that power supply 480 has failed.

Controller 1020 may cause charge pump 1010 to discharge its charge on non-volatile switch 1030 if or when controller 1020 has determined that power supply 480 has failed. The charge pump low may cause non-volatile switch 1030 to switch from a “zero” state to a “one” state. Non-volatile switch 1030 may be configured to normally be in a “zero” state and to switch from a “zero” state to a “one” state if or when it receives the charge discharge from charge pump 1010.

Non-volatile switch 1030 may be configured to act as an open circuit if or when it is in a “zero” state, i.e. if or when power supply 480 has not failed. In such scenarios, first data signals 1072 may travel from first connector 404 to network interface 440 and second data signals 1073 may travel from network interface 440 to second connector 406. Non-volatile switch 1030 may be further configured to act as a closed circuit, or short, it is in a “zero” state, i.e. if or when power supply 480 has failed. In such scenarios, first data signals 471 may travel from first connector 404 to second connector 406, and bypass network interface 440, which may no longer be operational because it may no longer be receiving power from power supply 480. In this manner, display panel moo, via the non-volatile circuit 1070, may provide a path for incoming data from a previous display panel 402 to pass-through the display panel moo to a next display panel 408 if or when a power supply 480 in the display panel woo has failed.

FIGS. 10A and 10B illustrate just one example of an architecture for a display panel 900 with a non-volatile circuit 1070, and those of skill in the art will appreciate that the specific architecture for the non-volatile circuit 1070 may vary, and is secondary to the functionality that it may provide, as described further herein.

Advantageously, and as illustrated in greater detail above, a display panel in accordance with one or more embodiments described above may provide additional fault tolerance if or when a power supply fails by allowing data to pass-through to the next display panels in the multi-panel display system. Thus, allowing the next display panels to display their corresponding data and minimizing the image loss caused by the power supply failure. Furthermore, the display panel may provide the additional fault tolerance even if or when the display panels have been coupled in a serial manner.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method of operating a display panel, the method comprising:
receiving data and power at the display panel;
at a power supply, generating a supply voltage from the received power for powering the display panel; and
forwarding the received data to an adjacent display panel when the power supply fails to generate the supply voltage.

2. The method of claim 1, further comprising:
when the power supply generates the supply voltage from the received power, displaying a portion of the received data at the display panel and forwarding the received data to the adjacent display panel.

3. The method of claim 1, further comprising:
determining, by the adjacent display panel, that the power supply of the display panel has failed; and
amplifying, by the adjacent display panel, the received data, in response to the determining.

4. The method of claim 3, wherein the determining, by the adjacent display panel, that the power supply of the display panel has failed comprises:
measuring an average peak amplitude of the received data; and
comparing the average peak amplitude with a predetermined peak amplitude for the received data.

5. The method of claim 1, wherein the received data comprises one or more of an Ethernet protocol format or an internet protocol (IP) format.

6. The method of claim 1, wherein the forwarding the received data comprises:
switching a circuit of the display panel to reroute the received data.

7. The method of claim 6, wherein the received data comprises a power signal and wherein the switching the circuit comprises:
powering the circuit of the display panel with the power signal of the received data.

8. A modular display of a multi-display system, the modular display comprising:
a plurality of light-emitting diodes (LEDs) arranged to form a display surface of the modular display;
a network switch configured to receive data and forward the received data to an adjacent modular display;
a power supply configured to power the plurality of LEDs and the network switch; and
a bypass circuit configured to forward the received data to the adjacent modular display when the power supply fails.

9. The modular display of claim 8, wherein the bypass circuit is configured to bypass the network switch.

10. The modular display of claim 9, wherein the bypass circuit comprises a power-fail switch.

11. The modular display of claim 9, wherein the bypass circuit comprises a charge pump and a non-volatile memory.

12. The modular display of claim 8, further comprising:
a first data connector configured to receive the data to be displayed at the display surface; and
a second data connector configured to be coupled to the adjacent modular display, wherein the bypass circuit is configured to forward the received data from the first data connector to the second data connector.

13. The modular display of claim 12, wherein the bypass circuit is powered from power received via the first connector.

14. The modular display of claim 8, further comprising:
a signal boosting circuit configured to amplify a signal level of the received data when a power supply of an adjacent previous modular display has failed.

15. The modular display of claim 14, wherein the signal boosting circuit is configured to amplify the signal level of the received data by:
measuring an average peak amplitude of the received data;
comparing the measured average peak amplitude with a predetermined peak amplitude; and
applying a gain to the received data based on the comparing.

16. The modular display of claim 8, wherein the received data comprises one or more of an Ethernet protocol format or an internet protocol (IP) format.

17. The modular display of claim 8, wherein the bypass circuit comprises an auxiliary power supply for powering the bypass circuit.

18. The modular display of claim 8, wherein the bypass circuit comprises an auxiliary power supply configured to power the network switch when the power supply fails.

19. The modular display of claim 18, further comprising:
a selection circuit configured to select power supplied to the network switch between the power supply and the auxiliary power supply.

20. The modular display of claim 19, wherein the selection circuit comprises a blocking diode.

21-31. (canceled)
